(19) United States
(12) Patent Application Publication
(10) Pub. No.: US 2008/0106065 A1
(43) Pub. Date: May 8, 2008

(54) SYSTEM AND APPARATUS FOR TRAILER HITCH ASSEMBLY

(76) Inventor: Edmund A. Cutts, Oxford, MD (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/678,311

(22) Filed: Feb. 23, 2007

Related U.S. Application Data
(60) Provisional application No. 60/864,173, filed on Nov. 3, 2006.

(51) Int. Cl. B60D 1/00

(52) U.S. Cl. 280/504

(57) ABSTRACT

An improved trailer assembly capable of carrying a load and having improved stability characteristics is disclosed. Specifically, in a preferred embodiment, the trailer hitch assembly has an interconnecting member pivotally connected to a first member and a second member. The interconnecting member has a longitudinal center line, relative to the first member and second member pivots. The first member is pivotally connected at its one end to the interconnecting member, wherein the first member is capable of pivoting in a horizontal direction relative to the longitudinal center line. The center member is pivotally connected at its one end to the interconnecting member, wherein the second member is capable of pivoting in a vertical direction relative to the longitudinal center line. Thus, a towed vehicle operably connected to the trailer hitch assembly, which for example is a trailer or carrier having a narrow width, is substantially restricted from rotating about a longitudinal axis during transit or during a turn, which decreases the risk of tipping and otherwise provides increased stability.

### CROSS REFERENCE TO RELATED PATENT APPLICATIONS

The present application claims the benefit of U.S. Provisional Patent Application Ser. No. 60/864,173, filed Nov. 3, 2006, the entirety of which is hereby incorporated by reference.

### FIELD OF INVENTION

This invention relates to trailer hitch assembly and particularly an improved trailer and hitch assembly having increased stability during use thereof.

### BACKGROUND OF THE INVENTION

Hitch assemblies are typically used to connect a vehicle (“towing vehicle”) with an object that is being towed behind the vehicle (“towed vehicle”). A common, and perhaps the most common, towing hitch assembly consists of a ball and socket assembly fabricated from metal. The common ball and socket assembly will now be described in greater detail. On the towed vehicle, typically a wheeled trailer, a complimentary socket is adaptably mated to detachably receive the ball portion from a stable towing assembly. The ball portion of the assembly is connected to a towing vehicle, most commonly through a metal extension, such that the ball extends a short distance away from the towing vehicle. Typically, the metal extension is attached to a generally longer piece of metal or tang that is attached preferably below but usually not directly on the rear bumper of a towing vehicle. This allows the ball to extend from behind the towing vehicle, such as a pick-up truck, four wheel automobile, tractor, truck, and the like. The towed vehicle can be a camper or the like; however, often times the towed vehicle is a trailer having essentially a frame mounted upon an axle or axles, which in turn are connected to or supported by a plurality of wheels.

A conventional ball and socket assembly is often times an unstable configuration to interconnect the towing vehicle to the vehicle being towed. Under certain operating conditions the ball and socket assembly allows for undesirable sway and movement of the towed vehicle. This can arise from improper weight distribution, winding roads, high wind, or the speed at which the towed vehicle is being towed, which can cause for example an oscillation like “fish tailing.” Additionally, this instability can be aggravated when the towing outfit is overtaken by another vehicle, when it is overtaken by another vehicle which causes air to be forced between two vehicles, or when the wide wheel spacing of the towed vehicle allows for varying road conditions on each wheel.

Another undesirable characteristic of the ball and socket assembly is the instability of the towed vehicle during turning. The ball and socket are capable of generally unrestricted movement relative to each other. As such, the ball and socket assembly directs movement of the towed vehicle in several directions including a vertical axis (pitching), a horizontal axis (snaking) and equally important, a rotational axis (tipping). If the towed vehicle is directly behind the towing vehicle, a longitudinal axis is generally extends as a straight line from the back of the towed vehicle, lengthwise through the trailer hitch assembly, then lengthwise through the towing vehicle, and finally exiting through the front of the towing vehicle. It is around this longitudinal axis that the typical ball and socket assembly allows the towed vehicle to rotate. Because the ball and socket assembly allows rotation, in transit the momentum of the towed vehicle can cause it to rotate about the longitudinal axis and to tip or flip the towed vehicle. (In general terms, the momentum of an object can be thought of as the tendency for an object to continue to move in its direction of travel). The momentum on the towed vehicle generally arises when the towing vehicle that is pulling the towed vehicle takes a turn, and becomes greater as the speed of the towing vehicle increases.

During a turn, the towed vehicle often time becomes unstable as them momentum of the towed vehicle causes it to want to maintain its current direction, resulting in a tendency for the towed vehicle to roll onto its side or tip. Because the ball and socket assembly does not prohibit rotational movement about a longitudinal axis (or, for that matter, any axis), what normally restrains the towed vehicle from rolling onto its side is the base frame of the towed vehicle, which has wheels along the width of the base frame that contact the ground. The wheels, which are normally connected to the base of the trailer at or near its sides, counteract the momentum for the vehicle to roll onto its side. Generally, the wider the frame of the towed vehicle base, the more stable the towed vehicle becomes during turning.

The wheels (connected to the base of the towed vehicle), however, provide a limited counteracting effect against the tendency of a towed vehicle to roll during a turn, which in many instances is not sufficient enough to counteract the momentum of the towed vehicle. Generally, the wider the based frame, the greater the counteracting effect to tipping. In this regard, it was often times undesirable to manufacture a narrow base frame but instead wider base frames. However, due to laws and local ordinances governing vehicle size as well as practical considerations, the width of the base frame is generally no wider than the width of the towing vehicle. Thus, the width of a towed vehicle can only be increased up to a certain amount.

Accordingly, there is a need for an improved trailer hitch assembly having improved stability characteristics. There is also a need for an improved trailer hitch assembly having improved stability characteristics for towing a narrow towing vehicle.

### BRIEF DESCRIPTION OF THE DRAWINGS

FIG. 1 is a first perspective view of the trailer hitch assembly according to one embodiment of the present invention;

FIG. 2 is a second perspective view of a trailer hitch assembly according to one embodiment of the present invention;

FIG. 3 is an exploded perspective view of a trailer hitch assembly according to one embodiment of the present invention;

FIG. 4 is an exploded perspective view of a trailer hitch assembly according to another embodiment of the present invention;

FIG. 5a is a side view of a trailer according to one embodiment of the present invention;

FIG. 5b is a top view of the trailer of FIG. 5a.

### SUMMARY OF THE INVENTION

It is an object of the present invention to provide an improved trailer hitch assembly.

Another object of the present invention is to provide an improved trailer hitch assembly which improves stability of a vehicle being towed by restricting rotational movement of the towed vehicle.

Yet another object of the present invention is to provide an improved trailer assembly capable of carrying a load and having improved stability characteristics during turning.

A further object of the present invention is to provide an improved trailer assembly that consists of few moving parts, such that the manufacture thereof is simple and cost-effective, making assembly and cleaning easy and efficient. In addition, due to the configuration of the present invention, the trailer hitch assembly of the present invention is universal in application such that (1) either end of the assembly can be removably secured to the receiving apparatus of a towing vehicle or a towed vehicle and (2) the assembly is adapted to be removably secured to a variety of receiving apparatus (such as one that is capable of receiving, for example, a ball and socket assembly).

These and other objects are met by the present invention, which in one aspect is a trailer hitch assembly having an interconnecting member pivotally connected to a first member and a second member. In one preferred embodiment, the interconnecting member has a longitudinal center line, relative to the first member and second member pivots. The first member is pivotally connected at its one end to the interconnecting member, wherein the first member is capable of pivoting in a horizontal direction relative to the longitudinal center line. The second member is pivotally connected at its one end to the interconnecting member, wherein the second member is capable of pivoting in a vertical direction relative to the longitudinal center line.

In one embodiment, the first member is removably secured to a towing vehicle and the second member is removably secured to a towed vehicle. In another embodiment, the second member is removable secured to a towing vehicle and the first member is removably secured to a towed vehicle. The first member, second member and interconnecting member may be comprised of suitably rigid material including but not limited to steel, aluminum, iron, brass, plastic, metal a metal alloy or any combination thereof.

In yet another aspect, the present invention is a trailer hitch for removably coupling a towing vehicle with a vehicle to be towed, the trailer hitch having a first member, an upper flange, a lower flange, an interconnecting member, a second member, a left flange and a right flange. The first member is connected to the upper flange, which has an upper pivot hole. The upper flange extends longitudinally from a top portion of the first member. The first member is also connected to a lower flange, which has a lower pivot hole. The lower flange extends longitudinally from a lower portion of the first member. When connected to and extending from the first member, the upper pivot hole (of the upper flange) and the lower pivot hole (of the lower flange) are in vertical alignment with each other.

The second member is connected to the left flange, which has left pivot hole. The left flange extends longitudinally from a side portion of the second member. The second member is also connected to a right flange, which has a right pivot hole. The right flange extends longitudinally from an opposite side portion of the second member with. When connected to and extending from the second member, the left pivot hole (of the left flange) and the right pivot hole (of the right flange) are in horizontal alignment with each other.

The interconnecting member had a longitudinal center line, a vertical pivot device receiving hole and a horizontal pivot device receiving hole. The interconnecting member is pivotally connected to the lower flange and the upper flange through a securing device secured within the vertical pivot device receiving hole ( the vertical pivot device receiving hole, the lower pivot hole and the upper pivot hole are all in vertical alignment with each another). In addition, the interconnecting member is pivotally connected to the left flange and the right flange through another securing device secured within the horizontal pivot device receiving hole (the horizontal pivot device receiving hole, the right pivot hole and the left pivot hole are all in vertical alignment with each another).

In yet another aspect, the present invention is a trailer assembly having an interconnecting member, a first member, a second member and a frame with wheels. The interconnecting member has a longitudinal center line. The first member is pivotally connected to the interconnecting member and can pivot in a horizontal direction relative to the longitudinal center line. The second member is pivotally connected to the interconnecting member such that second member can pivot in a vertical direction relative to the longitudinal center line. The frame is connected to either the second member or the first member. The frame has a predetermined frame width and capable of supporting a load, preferably a narrow frame with for convenience of use. The frame is connect to at least one wheel and axle assembly.

In one embodiment, the trailer assembly has a frame width of less than about 3 feet. In another embodiment, the trailer assembly has a frame width of less than about 2 feet. Preferably, the frame width falls in a range of about 18 inches to about 14 inches. In yet another embodiment, the trailer assembly additionally has a load securing device including but not limited to one or more clamps that are secured to the frame and which are used to removably secure a load on top of the frame, braces secured to the frame to restrain the load, ropes used to tie down the load to the frame, and the like.

### DETAILED DESCRIPTION OF THE INVENTION

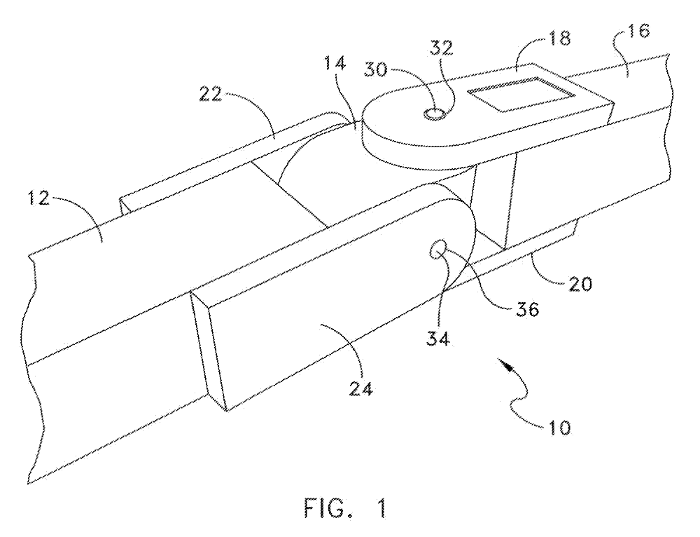

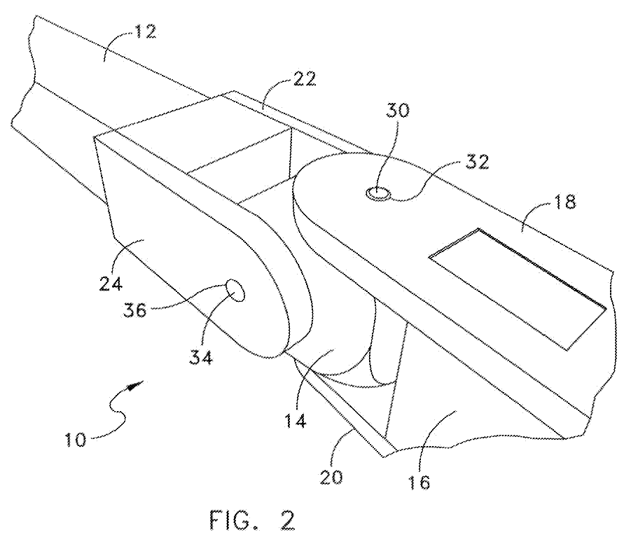

Reference is made generally to FIGS. 1-3, which show the trailer hitch assembly 10 of one embodiment of the present invention. The trailer hitch assembly 10 comprises an interconnecting member 14 pivotally connected to both a first member 16 and a second member 12. The interconnecting member 14 has a longitudinal center line 70 in relation to which the first member 16 and second member 12 pivots. (Generally, if the towed vehicle is directly behind the towing vehicle, a longitudinal axis generally extends as a straight line from the back of the towed vehicle lengthwise through the trailer hitch assembly of the present invention and finally through the front of the towing vehicle.) The first member 16 is pivotally connected at one end to the interconnecting member 14. Pivoting of the first member 16 is about a vertical pivot axis of the interconnecting member 14, resulting in pivoting of the first member 16 in a horizontal direction relative to the longitudinal center line 70. The second member 12 is pivotally connected at one end to the interconnecting member 14 about a horizontal axis. As such, the second member 12 is capable of the pivoting in a vertical direction relative to the longitudinal center line 70. The interconnecting member 14, first member 16 and second member 12 can be comprised of any suitable rigid material capable of withstanding forces associated with towing including but not limited to steel, aluminum, iron, brass, plastic, bronze, stainless steel, a metal alloy or any combination or composites thereof. Preferably, the material is plastic, stainless steel, which is highly resistant to corrosive forces such as rust and the like.

It is understood that either the first member 16 or second member 12 can be removably secured to a towing vehicle including but no limited to a four wheeled vehicle, pick-up truck and the like. In that way, the trailer hitch assembly 10 of the present invention is universal in application. For example, because either end of the assembly can be removably secured to the receiving apparatus of a towing vehicle or a towed vehicle, connection of the assembly is simple and no specialized knowledge would be needed. Further, the assembly is adapted to be removably secured to a variety of receiving apparatus generally available in the prior art (such as one that is capable of receiving, for example, a ball and socket assembly). In one preferred embodiment, the receiving apparatus or receiver comprises an aperture that is substantially square. The receiving apparatus is generally secured to a towing vehicle, for example by welding the receiving apparatus to the chassis of a truck under the bumper. The aperture is adapted to receive either the first member 16 or second member 12 and can be secured with a securing device through alignable holes in both the utilized member and receiving apparatus. It is also understood, however, that the trailer hitch assembly 10 removably connected to a wheeled frame can be moved manually in a “dolly”-like fashion. In such an instance, the assembly is connected to a suitable device which allows a person to manually push or pull the wheeled frame through use of the assembly 10 and device. For example, the device may be modified wheel barrow having a receiver at one end that removably secures the trailer hitch assembly 10.

The member (either first member 16 or second member 12) secured to the towing vehicle is capable of being telescopically fitted and secured within a receiver (not shown) connected to the towing vehicle. In one embodiment, a pair of traverse apertures are provided in the sides (or, alternatively, top and bottom) or the receiver. Corresponding apertures (not shown) are provided within the member that is secured to the towing vehicle. The apertures are aligned such that a trailer hitch assembly securing device including but not limited to a linchpin, screw, fastener, bolt and the like is inserted through the corresponding aperture and pair of traverse apertures to secure either the first member 16 or second member 12 to the towing vehicle. The trailer hitch assembly securing device may be used in connection with a suitable lock to maintain the trailer hitch assembly securing device in the proper position.

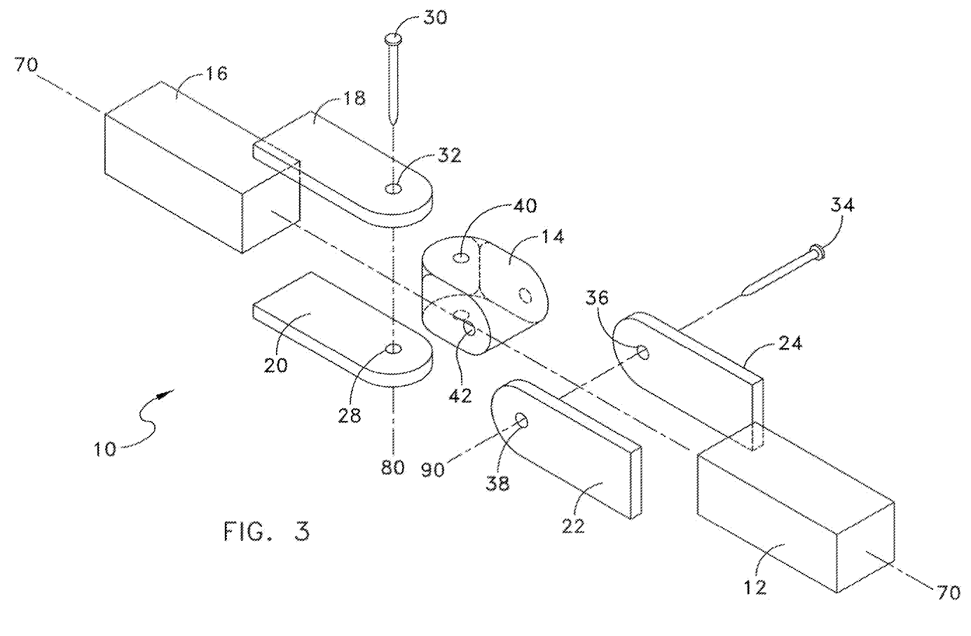

Referring specifically to FIG. 3, the trailer hitch assembly 10 of the present invention in another embodiment can comprise a first member 16, an upper flange 18, a lower flange 20, an interconnecting member 14, a second member 12, a left flange 22 and a right flange 24. The first member 16 is connected to the upper flange 18, which comprises an upper pivot hole 32. The upper flange 18 extends from a top portion of the first member 16 such that the upper pivot hole 32 is in a generally vertical alignment position. The first member 16 is also connected to a lower flange 20. The lower flange 20 comprises a lower pivot hole 28 and extends from a lower portion of the first member 16, such that the lower pivot hole 28 is generally in vertical alignment with the upper pivot hole 32 along vertical axis 80. Stated another way, both lower pivot hole 28 and upper pivot hole 32 are in alignment along vertical axis 80. Both the upper flange 18 and lower flange 20 can be secured to the first member 16 through a variety of methods, including but not limited to gluing, fastening, screwing, welding, etc.

The interconnecting member 14 comprises a longitudinal center line 70, a vertical pivot device receiving hole 40 and a horizontal pivot device receiving hole 42. The interconnecting member 14 can be pivotally connected to the lower flange 20 and the upper flange 18. This can be achieved by aligning vertical pivot device receiving hole 40, upper pivot hole 32 and lower pivot hole 28 along vertical axis 80. A securing device 30, including but not limited to a screw, pin, bolt, linchpin and the like, is fitted through and secured within the vertical pivot device receiving hole 40, upper pivot hole 32 and lower pivot hole 28 and may optionally be secured in place with a locking device (not shown). The first member 16 (and, correspondingly, upper flange 18 and lower flange 20) is thus capable of pivoting about vertical axis 80 and in a horizontal direction relative to longitudinal center line 70.

The interconnecting member 14 is also pivotally connected to the left flange 22 and right flange 24, as described in more detail below. The second member 12 is connected to the left flange 22. The left flange 22 contains a left pivot hole 38. The left flange 22 extends lengthwise from a side portion of the second member 12 such that the left pivot hole 38 is at distance away from the second member 12 in a horizontal alignment (generally, between about 1 to about 10 inches). The second member 12 is also connected to a right flange 24, which has a right pivot hole 36. The right flange 24 extends from an opposite side portion (with respect to the left flange 22 side) of the second member 12. In this position, the right pivot hole 36 is in a horizontal alignment with left pivot hole 38, such that both holes are aligned along horizontal axis 90.

The interconnecting member 14 can be pivotally connected to the left flange 22 and the right flange 24. This is achieved by aligning horizontal pivot device receiving hole 42, left pivot hole 38 and right pivot hole 36 along horizontal axis 90. A second securing device 34, which like securing device 30 includes but is not limited to a screw, pin, bolt, linchpin and the like, is fitted through and secured within the horizontal pivot device receiving hole 42, left pivot hole 38 and right pivot hole 32. Thus, the second member 12 (and, correspondingly, left flange 22 and right flange 24) is thus capable of pivoting about horizontal axis 90 in a vertical direction relative to longitudinal center line 70. Optionally a locking device to secure second device 34 in place may be utilized.

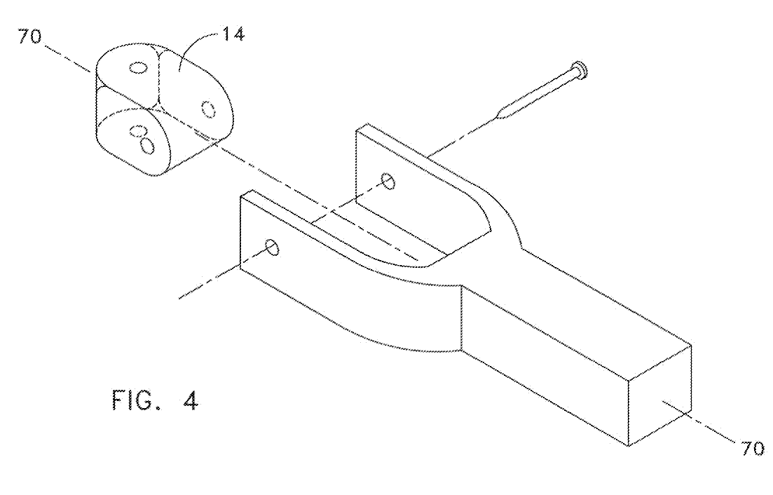

In another embodiment as illustrated in FIG. 4, the trailer hitch assembly of the present invention is comprised in its most simplest form of three elements: (1) a member, (2) an interconnecting member 14 and (3) a securing device that pivotally secures the member to the interconnecting member 14. If the member is pivotally secured to the interconnecting member 14 such that the member is capable of pivoting in a vertical direction relative to the longitudinal center line 70 of the interconnecting member 14, then such a member is the first member 12 (see FIG. 3). However, if the same member is rotated 90 degrees and pivotally secured to the interconnecting member 14 such that the member is capable of pivoting in a horizontal direction relative to the longitudinal center line 70 of the interconnecting member 14, then such a member is the second member 16 (see FIG. 3). The need to fabricate many parts to create a trailer hitch assembly (as is present in the prior art) is not necessary with the trailer hitch assembly of the present invention. In addition, the member comprised of flanges, which extend from the main body and are disposed on opposite sides, can be fabricated to create one solid structure. This increases the strength and durability of the member from breaking, as well as simplifies the manufacturing process, as well as assembly and disassembly.

Referring back to FIGS. 1-3, the trailer hitch assembly 10 allows for limited movement of a towed vehicle or object in a vertical direction relative to the longitudinal center line 70 (pivoting about a horizontal axis). Likewise the trailer hitch assembly allows for limited movement in a horizontal direction relative to the longitudinal center line 70 (pivoting about a vertical axis). The trailer hitch assembly 10, unlike the traditional ball and socket assembly of the related art, restricts rotation of first member 16 and second member 12 to only a limited number of directions (e.g., vertical) with respect to each other. Thus, a towed vehicle operably connected to the trailer hitch assembly 10 of the present invention (which, in turn, is secured to a towing vehicle) is substantially restricted from rotating about a longitudinal axis, which for example is longitudinal center line 70 of the present invention, during transit or during a turn. However, the trailer hitch assembly 10 still provides freedom of movement for the towed vehicle, which is needed when the towed vehicle traverses uneven road, graded roads (e.g., up and down a hill) or is turning behind the towing vehicle. For example, the towed vehicle using the trailer hitch assembly 10 of the present invention can move and pivot relative to the towing vehicle in a generally vertical and horizontal direction.

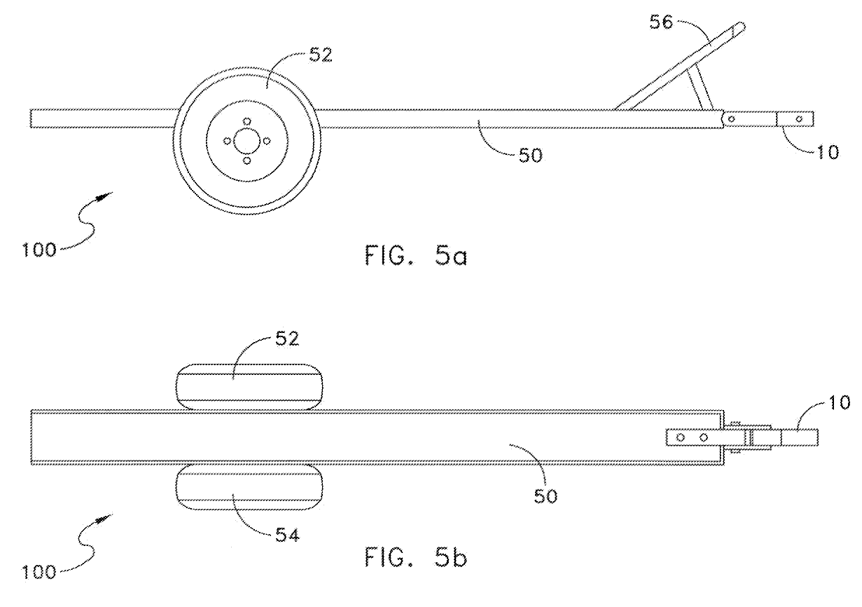

Referring to FIGS. 5a and 5b, in another embodiment the present invention is a trailer assembly 100 comprising a trailer hitch assembly 10 (having an interconnecting member 14, a first member 16 and a second member 12) operably connected to a frame 50 and wheels 52, 54. The frame 50 can be connected to either the second member 12 or the first member 16. In addition, a load securing device 56 including but not limited to clamps, a securing brace to securely confine a load, rope, chains and the like can also be utilized. The wheels 52, 54 are operably connected to a wheel axle assembly (not shown) that is secured to the frame 50. In one embodiment, wheels 52, 54 are separately pivotally connected, via axles independent to one another, to the frame. The wheels are thus capable of generally moving in a vertical direction relative to the longitudinal center line 70. This allows for more “grip” or otherwise increased contact between both wheels 52, 54 and the ground over uneven road or terrain, during extremely sharp turns, etc. In another embodiment, the trailer assembly comprises only one wheel, the wheel positioned approximately along the centerline of the frame 50 and towards the rear.

The frame 50 has a predetermined width generally not wider than the vehicle towing the trailer assembly 100 and is capable of supporting a load (Examples of specific loads that may be transported by the trailer assembly 100 include but are not limited to motorcycles and other two wheeled vehicles.) In a preferably embodiment, a frame 50 is narrow for convenience of use. In this preferred embodiment, the trailer hitch assembly 10 provides for increased stability of the frame 50 and thus the narrow frame 50 can be utilized without the high risk of the frame and load tipping or rolling over. Prior trailers or towed vehicles rely on a wide frame base in order to compensate for the momentum forces tending to roll a trailer over during turning (which is aided by the ball and socket assembly allowing the towed vehicle to rotate). The trailer assembly has frame width of less than about 4 feet. In another embodiment, the trailer assembly has a frame width of less than about 3 feet. Preferably, the frame width is about 2 feet.

Whereas the present invention has been described in relation to the accompanying drawings, it should be understood that other and further modifications, apart from those shown or suggested herein, may be made within the spirit and scope of the present invention. It is also intended that all matter contained in the foregoing description or shown in the accompanying drawings shall be interpreted as illustrative rather than limiting.

What is claimed is:

1. A trailer hitch assembly comprising:
an interconnecting member having a longitudinal center line;
a first member pivotally connected at one end to the interconnecting member, the first member capable of pivoting in a horizontal direction relative to the longitudinal center line of the interconnecting member; and
a second member pivotally connected at one end to the interconnecting member, the second member capable of pivoting in a vertical direction relative to the longitudinal center line of the interconnecting member.

2. The trailer hitch of claim 1, wherein the first member is removable secured to a towing vehicle at its other end, and wherein the second member is removably secured to a towed vehicle at its other end.

3. The trailer hitch of claim 1, wherein the second member is removable secured to a towing vehicle at its other end, and wherein the first member is removably secured to a towed vehicle at its other end.

4. The trailer hitch of claim 1, wherein the first member, second member and interconnecting member are comprised of steel, aluminum, iron, brass, a metal alloy or a combination thereof.

5. A trailer hitch for removably coupling a towing vehicle with a vehicle to be towed, the trailer hitch comprising:
a first member;
an upper flange having an upper pivot hole, the upper flange connected to and extending from a top portion of the first member;
a lower flange having a lower pivot hole, the lower flange connected to and extending from a lower portion of the first member, wherein the upper pivot lower pivot hole is in vertical alignment with the upper pivot hole;
an interconnecting member comprising a longitudinal center line, a vertical pivot device receiving hole and a horizontal pivot device receiving hole, the interconnecting member pivotally connected to the lower flange and the upper flange through a securing device secured within the vertical pivot device receiving hole, the lower pivot hole and the upper pivot hole, which are all in vertical alignment with each another,
whereby the first member is capable of pivoting in a horizontal direction relative to the longitudinal center line of the interconnecting member;
a left flange having a left pivot hole, the left flange pivotally connected to the interconnecting member;
a right flange having a right pivot hole, the right flange pivotally connected to the interconnecting member, wherein the interconnecting member is pivotally connected to the left flange and the right flange through a second securing device secured within the horizontal pivot device receiving hole, the left pivot hole and the right pivot hole, which are all in horizontal alignment with each another; and
a second member, wherein the left flange and right flange are connected to and extend from the second member, whereby the second member is capable of pivoting in a vertical direction relative to the longitudinal center line of the interconnecting member.

6. The trailer hitch of claim 5, wherein the first member, upper flange, lower flange, interconnecting member, left flange, right flange and second member are comprised of steel, aluminum, iron, brass, a metal alloy or a combination thereof.

7. A trailer assembly comprising:
an interconnecting member having a longitudinal center line;
a first member pivotally connected at one end to the interconnecting member, the first member capable of pivoting in a horizontal direction relative to the longitudinal center line of the interconnecting member;
a second member pivotally connected at one end to the interconnecting member, the second member capable of pivoting in a vertical direction relative to the longitudinal center line of the interconnecting member;
a frame connected to the second member or the first member, the frame having a predetermined frame width and capable of supporting a load; and
at least one wheel and axle assembly operably connected to the frame.

8. The trailer assembly of claim 7, wherein the predetermined frame width is less than about 2 feet.

9. The trailer assembly of claim 8, wherein the predetermined frame width is less than about 20 inches.

10. The trailer assembly of claim 7, wherein the predetermined frame width if about 15 inches.

11. The trailer assembly of claim 7, further comprising a load securing device.

12. A trailer assembly comprising:
an interconnecting member having a longitudinal center line;
a first member pivotally connected at one end to the interconnecting member, the first member capable of pivotally in a horizontal direction relative to the longitudinal center line of the interconnecting member;
a second member pivotally connected at one end to the interconnecting member, the second member capable of pivoting in a vertical direction relative to the longitudinal center line of the interconnecting member;
a frame connected to the second member or the first member, the frame having a predetermine frame width and capable of supporting a load; and
at least one wheel and axle assembly operably connected to the frame, whereby substantially all resistance to traverse tipping or rolling is provided by a towing vehicle.

13. A trailer and hitch assembly system comprising:
an interconnecting member having a longitudinal center line;
a first member pivotally connected at one end to the interconnecting member, the first member capable of pivoting in a horizontal direction relative to the longitudinal center line of the interconnecting member;
a second member pivotally connected at one end to the interconnecting member, the second member capable of pivoting in a vertical direction relative to the longitudinal center line of the interconnecting member;
a frame connected to the second member or the first member, the frame having a predetermined frame width and capable of supporting a load;
a wheel and axle assembly operably connected to the frame; and
a receiving apparatus, wherein the first member or the second member can be removably secured to the receiving apparatus.

14. The system of claim 13, wherein the receiving apparatus comprises a receiving aperture that is substantially square in shape.
